(19) United States
(12) Patent Application Publication
(10) Pub. No.: US 2015/0246451 A1
(43) Pub. Date: Sep. 3, 2015

(54) Sliding knife

(71) Applicant: Glenn Robinson, Parkland, FL (US)

(72) Inventor: Glenn Robinson, Parkland, FL (US)

(21) Appl. No.: 14/544,757

(22) Filed: Feb. 11, 2015

Related U.S. Application Data
(60) Provisional application No. 61/965,892, filed on Feb. 11, 2014.

(51) Int. Cl. B26B 1/08

(52) U.S. Cl. CPC B26B 1/08

(57) ABSTRACT

The present invention provides for a utility knife comprising a handle with a button channel, an extendable compartment and an extendable one walled blade holder with blade and a button for moving the extendable compartment and blade holder.

### RELATED APPLICATION

This application is related to U.S. application Ser. No. 61/965,892 which was filed on Feb. 11, 2014 and entitled “Sliding Knife”.

### BACKGROUND OF THE INVENTION

Field of the Invention

This invention relates to a tool and more specifically, to a knife with an extendable compartment and a sliding blade holder with disposable blade.

Summary of the Invention

In one embodiment, the present invention provides for a utility knife comprising: a handle comprising an internal space; an extendable compartment having an opening leading to a cavity, at least a portion of the extendable compartment is situated within at least a portion of the space of the handle during a storage position, the extendable compartment is designed to be slidably extended away from the handle during a first extended position; a blade holder comprising one wall and a disposable blade attachable and removable from the wall of the blade holder, the blade holder and blade are situated within the cavity of the extendable compartment during the storage position and the first extended position, at least a portion of the blade holder and a portion of the blade is designed to be slidably extended away from the extendable compartment and allow at least a portion of the blade to protrude from the opening of the extendable compartment during a second extended position for usage; and a mechanism for slidably extending and retracting the extendable compartment and blade holder with the blade.

In another embodiment, the blade has at least one side with a sharp edge for cutting. In yet another embodiment, the knife further comprises a safety mechanism that prevents the blade from protruding until the extendable compartment is fully extended.

In still another embodiment, the mechanism comprises a track which allows the blade holder with blade to slideably move within the extendable compartment. In still yet another embodiment, the mechanism comprises a track which allows the extendable compartment to slideably move within the handle.

In a further embodiment, the mechanism further comprises a button, and the button contacts at least a portion of the blade holder. In yet a further embodiment, the handle further comprises a button channel, and the button is designed to be moved along the button channel to move the blade holder into the extendable position.

In still a further embodiment, the knife further comprises a storage cartridge with a plurality of disposable blades. In still yet a further embodiment, the cartridge is stored within a portion of the extendable compartment. In another further embodiment, the cartridge is stored within a portion of the handle.

In another embodiment, the button channel comprises two parallel segments connected together by a perpendicular segment, the first parallel segment been situated behind the second parallel segment, and the button is designed to be moved along the first parallel segment of the button channel thereby allowing the extendable compartment to extend away from the handle in the first extended position, and the button is designed to be moved along the perpendicular line then to the second parallel segment of the button channel thereby allowing at least a portion of the blade holder and the blade to be extended and a portion of the blade to be exposed in the second extended position for usage. In yet another embodiment, the knife further comprises a blade release button.

In still another embodiment, the present invention provides for a utility knife comprising: a handle comprising an internal space; an extendable compartment slidably connected to one end of the handle, the extendable compartment having an opening, at least a portion of the extendable compartment is situated within at least a portion of the space of the handle during a storage position, the extendable compartment is designed to be extended away from the handle during a first extended position; a blade holder comprising one wall, and the blade holder is situated within the extendable compartment during the storage and the first extended position, the blade holder is designed to be extended away from the extendable compartment during a second extended position; a disposable blade disposed within the blade holder, at least a portion of the blade protruding from the opening of the extendable compartment during the second extended position; and a means for retracting and extending the blade between said first use position and a second non-use position.

In another embodiment, the knife further comprises a means for preventing said blade from being extended until said extendable compartment is fully extended. In a further embodiment, the knife further comprises means for storing additional blades.

In another further embodiment, the present invention relates to a folding utility knife comprising: a handle slidably connected to an extendable compartment, the handle comprising at least two side walls forming a space, the space of the handle designed to encase at least a portion of the extendable compartment during a closed position, the extendable compartment comprising an internal cavity leading to an opening, the extendable compartment designed to be extended away from the handle during a first extended position; a blade holder slidably connected to the extendable compartment, and the blade holder comprising one wall and designed to receive at least one blade, the blade holder designed to be extended away from the extendable compartment during a second extended position; and a device for extending and retracting the extendable compartment and the blade holder.

In yet another further embodiment, the knife further comprises a blade designed to be attached to the wall of the blade holder, at least a portion of the blade is exposed during the second extended position for use. In still another further embodiment, the device further comprises a safety locking mechanism. In still yet another further embodiment, the knife further comprises a blade storage compartment.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a frontal exploded view of one of the embodiments of the present invention;

FIG. 2 is a rear exploded view of FIG. 1;

FIG. 3 is a perspective view of the compartment in the extended position; and

FIG. 4 is a perspective view of the blade holder and compartment in the extended position.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

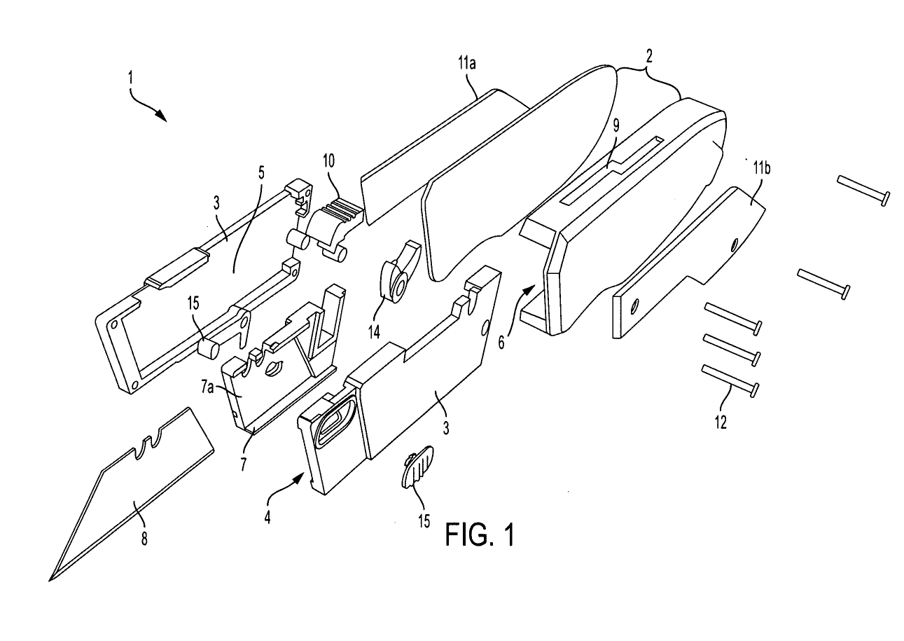

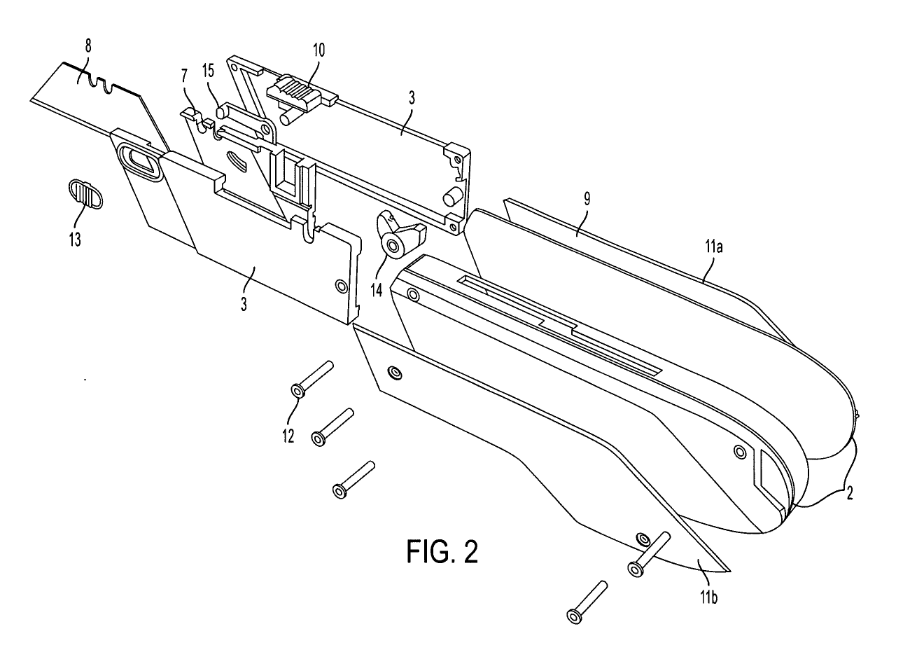

FIGS. 1-2 show one embodiment of the knife 1 of the present invention with a handle 2 forming a space 6; an extendable compartment 3 having an opening 4 leading to a cavity 5, at least a portion of the extendable compartment 3 is situated within at least a portion of the space 6 of the handle 2 during a storage position, the extendable compartment 3 is designed to be slidably extended away from the handle 2 during a first extended position; a blade holder 7 comprising one wall 7a and a disposable blade 8 attachable and removable from the wall 7a of the blade holder 7, the blade holder 7 and blade are situated within the cavity 5 of the extendable compartment 3 during the storage position and the first extended position, at least a portion of the blade holder 7 and a portion of the blade 8 is designed to be slidably extended away from the extendable compartment 3 and allow at least a portion of the blade 8 to protrude from the opening 4 of the extendable compartment 3 during a second extended position for usage; and a button channel 9 and a button 10 for slidably extending and retracting the extendable compartment 3 and blade holder 7 with the blade 8. The knife 1 further has handle plates 11a and 11b and a plurality of screws 12.

The extendable compartment 3 has a button 13 for releasing the blade. In another embodiment, the extendable compartment 3 has two pieces and is connected by bolt with protrusions 14 and the knife 1 further comprises a connector 15 for connecting the button 10 to the blade holder 7 and blade 8.

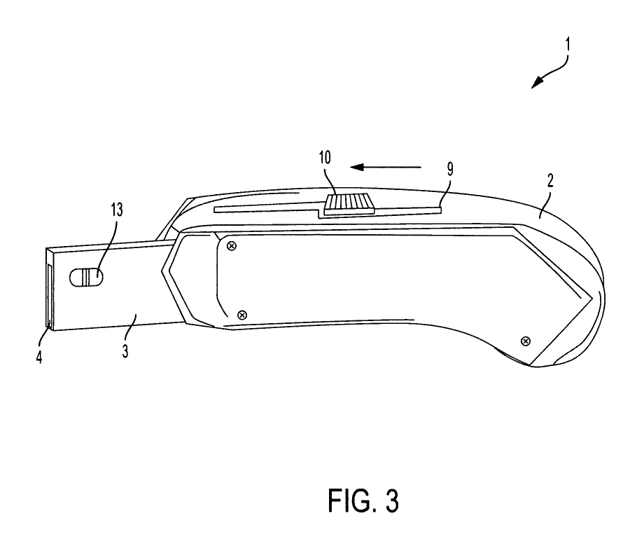

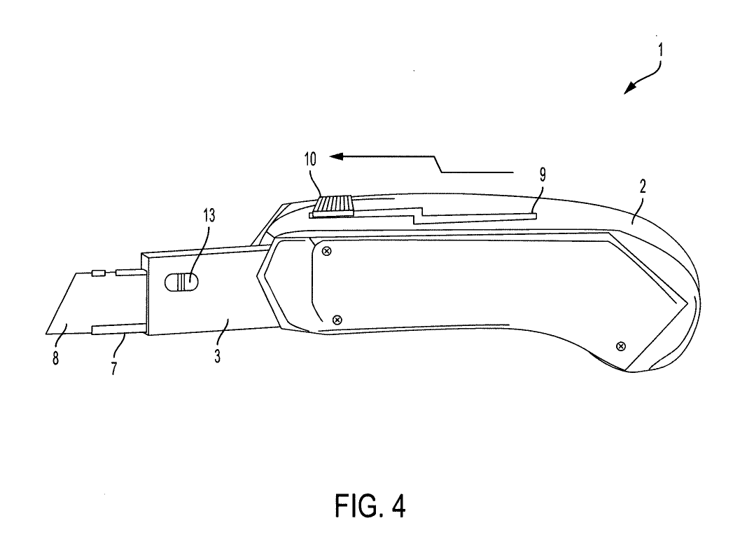

FIGS. 3-4 shows button channel 9 comprises two parallel segments connected together by a perpendicular segment, the first parallel segment been situated behind the second parallel segment, and the button is designed to be moved along the first parallel segment of the button channel 9 thereby allowing the extendable compartment 3 to extend away from the handle 2 in the first extended position (see FIG. 3), and the button 13 is designed to be moved along the perpendicular line then to the second parallel segment of the button channel 9 thereby allowing at least a portion of the blade holder 7 and the blade 8 to be extended and a portion of the blade 8 to be exposed in the second extended position for usage (see FIG. 4).

The mechanism including, but limited to the device for moving the movable element and the pivoting mechanism can be used and interchanged to form various embodiments of the present invention. Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A utility knife comprising:
a handle comprising an internal space;
an extendable compartment having an opening leading to a cavity, at least a portion of said extendable compartment is situated within at least a portion of said space of said handle during a storage position, said extendable compartment is designed to be slidably extended away from said handle during a first extended position;
a blade holder comprising one wall and a disposable blade attachable and removable from said wall of said blade holder, said blade holder and blade are situated within said cavity of said extendable compartment during said storage position and said first extended position, at least a portion of said blade holder and a portion of said blade is designed to be slidably extended away from said extendable compartment and allow at least a portion of said blade to protrude from said opening of said extendable compartment during a second extended position for usage; and
a mechanism for slidably extending and retracting said extendable compartment and blade holder with said blade.

2. The knife of claim 1 wherein said blade has at least one side with a sharp edge for cutting.

3. The knife of claim 1 further comprising a safety mechanism that prevent said blade from protruding until said extendable compartment is fully extended.

4. The knife of claim 1 wherein said mechanism comprises a track device which allows said blade holder with blade to slideably move within said extendable compartment.

5. The knife of claim 1 wherein said mechanism comprises a track which allows said extendable compartment to slideably move within said handle.

6. The knife of claim 1 wherein said mechanism further comprises a button, said button contacts at least a portion of said blade holder.

7. The knife of claim 6 wherein said handle further comprises a button channel, said button is designed to be moved along said button channel to move said blade holder and said extendable position.

8. The knife of claim 1 further comprises a storage cartridge with a plurality of disposable blades.

9. The knife of claim 8 wherein said cartridge is stored within a portion of said extendable compartment.

10. The knife of claim 8 wherein said cartridge is stored within a portion of said handle.

11. The knife of claim 7 wherein said button channel comprises two parallel segments connected together by a perpendicular segment, said first parallel segment been situated behind said second parallel segment, said button is designed to be moved along said first parallel segment of said button channel thereby allowing said extendable compartment to extend away from said handle in said first extended position, said button is designed to be moved along said perpendicular line then to said second parallel segment of said button channel thereby allowing at least a portion of said blade holder and said blade to be extended and a portion of the blade to be exposed in said second extended position for usage.

12. The knife of claim 1 further comprising a blade release button.

13. The knife of claim 1 further comprising a means for preventing said blade from being extended until said extendable compartment is fully extended.

14. A utility knife comprising:
a handle comprising an internal space;
an extendable compartment slidably connected to one end of said handle, said extendable compartment having an opening, at least a portion of said extendable compartment is situated within at least a portion of said space of said handle during a storage position, said extendable compartment is designed to be extended away from said handle during a first extended position;
a blade holder comprising one wall, said blade holder is situated within said extendable compartment during said storage and said first extended position, said blade holder is designed to be extended away from said extendable compartment during a second extended position;
a disposable blade disposed within said blade holder, at least a portion of said blade protruding from said opening of said extendable compartment during said second extended position; and
a means for retracting and extending said blade between said first use position and a second non-use position.

15. The knife of claim 14 further comprising a means for preventing said blade from being extended until said extendable compartment is fully extended.

16. The knife of claim 14 further comprises means for storing additional blades.

17. A folding utility knife comprising:
a handle slidably connected to an extendable compartment, said handle comprising at least two side walls forming a space, said space of said handle designed to encase at least a portion of said extendable compartment during a closed position, said extendable compartment comprising an internal cavity leading to an opening, said extendable compartment designed to be extended away from said handle during a first extended position;
a blade holder slidably connected to said extendable compartment, said blade holder comprising one wall and designed to receive at least one blade, said blade holder designed to be extended away from said extendable compartment during a second extended position; and
a device for extending and retracting said extendable compartment and said blade holder.

18. The knife of claim 17 further comprising a blade designed to be attached to said wall of said blade holder, at least a portion of said blade is exposed during said second extended position for use.

19. The knife of claim 17 wherein said device further comprises a safety locking mechanism.

20. The knife of claim 17 further comprising a blade storage compartment.
